(19) United States
(12) Patent Application Publication
(10) Pub. No.: US 2014/0085138 A1
(43) Pub. Date: Mar. 27, 2014

(54) EFFICIENT DETECTION OF MOVEMENT USING SATELLITE POSITIONING SYSTEMS

(71) Applicant: Aegis Mobility, Inc., Vancouver (CA)

(72) Inventor: Stephen J. Williams, Port Moody (CA)

(73) Assignee: Aegis Mobility, Inc., Vancouver (CA)

(21) Appl. No.: 14/038,462

(22) Filed: Sep. 26, 2013

Related U.S. Application Data
(60) Provisional application No. 61/706,507, filed on Sep. 27, 2012.

(51) Int. Cl. G01S 19/42

(52) U.S. Cl. CPC G01S 19/42
USPC 342/357.25

(57) ABSTRACT

The management of GPS sensor data in a mobile communication device. In one embodiment, a mobile device can implement a GPS sensor data sampling framework to minimize the number of GPS satellite fixes required to determine location or movement assessments. Additionally, in another embodiment, the mobile device can implement a heuristic-based processing routine to determine whether sampled GPS data is indicative of GPS signal reflections.

### CROSS-REFERENCE TO RELATED APPLICATION

This application claims the benefit of U.S. Provisional Application No. 61/706,507, entitled, EFFICIENT DETECTION OF MOVEMENT USING SATELLITE POSITIONING SYSTEMS and filed on Sep. 27, 2012, which is incorporated herein by reference.

### BACKGROUND

Many mobile devices, such as mobile telephones are equipped with Global Positioning System “GPS” sensors or devices. A GPS device provides several pieces of data regarding the location of a device. For example, GPS sensors can provide time information which is derived from a highly accurate time source powered by synchronized atomic clocks. It is the time signal that is used to measure the length of the path between the receiver and each satellite. GPS sensors can also provide position and altitude which are derived using the time of arrival of signals from the various satellites within range of the mobile device. Based on the number of available satellites, the position and altitude data can be in the form of three-dimensional position data. Still further, GPS sensors can provide velocity information, which is derived from the Doppler shift in the received signals, the Doppler is measured in three dimensions, but the velocity is presented in a two dimensional plane parallel to a tangent with the earth's surface at the location of device.

A GPS sensors is a primary sensor used by mobile devices to detect location and movement of the mobile device. Current approaches to GPS as a primary sensor in a mobile device has many drawbacks. In one aspect, continuous utilization of the GPS sensor can cause excessive battery drain on the mobile device. In another aspect, satellite signal reflection, such as from nearby building, can result in a false positive detection of movement. Still further, GPS sensor reads in traffic conditions can result in accurate assessments of movement.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of aspects of the mobile communication device;

FIG. 2 is a flow diagram illustrative of a GPS sampling data routine implemented by to mobile communication device; and

FIG. 3 is a flow diagram illustrative of a GPS sampling data routine implemented by to mobile communication device.

### DETAILED DESCRIPTION

The present disclosure corresponds generally to mobile device management. More specifically, aspects of the present disclosure correspond to the management of GPS sensor data in a mobile communication device. In one embodiment, a mobile device can implement a GPS sensor data sampling framework to minimize the number of GPS satellite fixes required to determine location or movement assessments. Additionally, in another embodiment, the mobile device can implement a heuristic-based processing routine to determine whether sampled GPS data is indicative of GPS signal reflections.

Although aspects of the system will be described to the drawings, flow diagrams, screen interfaces, and specific examples, one skilled in the relevant art will appreciate that the disclosed embodiments are illustrative in nature. Specifically, reference to specific wireless transmission protocols, illustrative context categories, or illustrative examples should not be construed as limiting should not be construed as limiting.

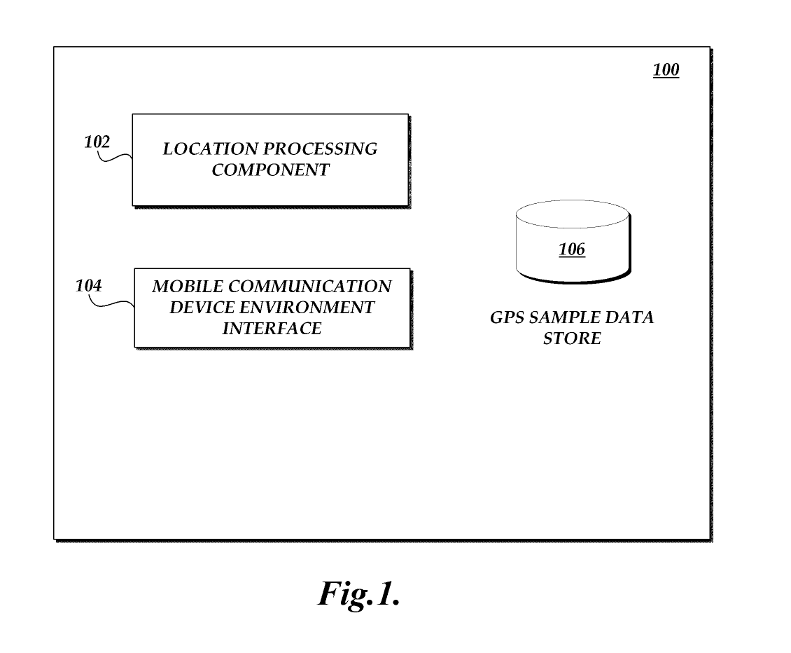

With reference now to FIG. 1, illustrative components for the mobile communication device 100 will be described. Although the operation of the various functions associated with the mobile communication device 100 will be described with regard to below components, one skilled in the relevant art will appreciate that the components are illustrative in nature. Illustratively, the mobile device 100 may be associated with computing resources such as central processing units and architectures, memory (e.g., RAM), mass storage or persistent memory, graphics processing units, communication network availability and bandwidth, etc. Generally, however, the mobile device 100 may include one or more processing units, such as one or more CPUs. The mobile device 100 may also include system memory, which may correspond to any combination of volatile and/or non-volatile storage mechanisms. The system memory may store information that provides an operating system component, various program modules, program data or other components. The mobile device 100 performs functions by using the processing unit(s) to execute instructions provided by the system memory. The mobile device 100 may also include one or more types of removable storage and one or more types of non-removable storage. Accordingly, the mobile device 100 may include additional components or alternative components to facilitate one or more functions.

As illustrated in FIG. 1, the mobile communication device 100 includes a location processing component 102 for processing GPS sensor data. In one aspect, the location processing component 102 can determine and implement GPS sampling algorithms to minimize GPS sensor battery drain in generating GPS sampling data. In another aspect, the location processing component 102 can process GPS sampling data to identify and eliminate GPS sampling data indicative of reflection of the GPS data.

With continued reference to FIG. 1, the mobile communication device 100 can also include a mobile communication device environment interface 104 for obtaining inputs corresponding to a mobile communication device environment. In an illustrative embodiment, the set of inputs can include information from one or more sensors that are capable of transmitting information or obtaining information from GPS sensors.

The mobile communication device 100 can further include a GPS sampling data store 106 for storing input information from GPS sensors associated with the mobile communication device or the various context assessment algorithms or processes used by the mobile communication device processing component to generate the mobile communication device context information.

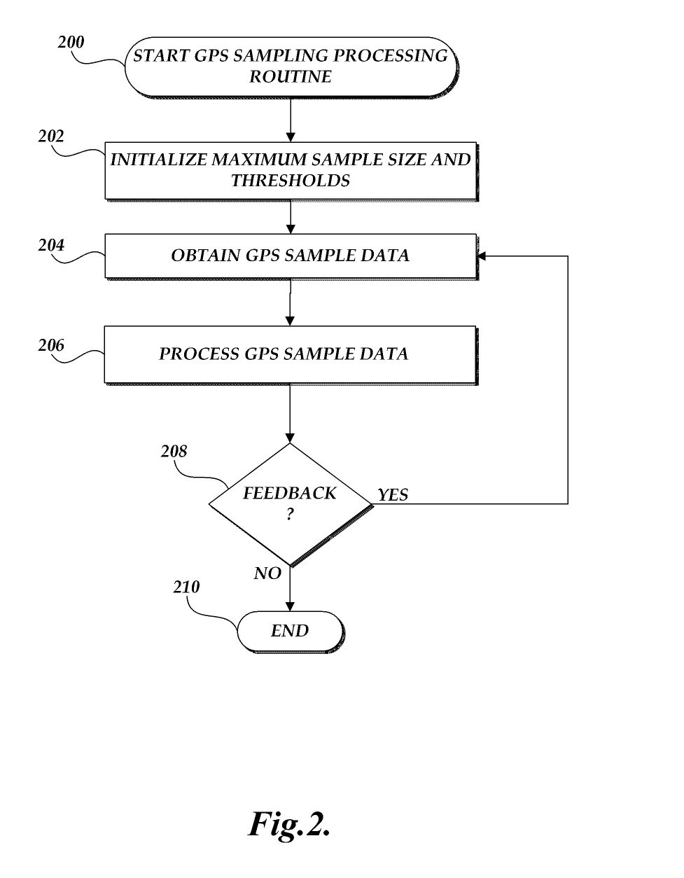

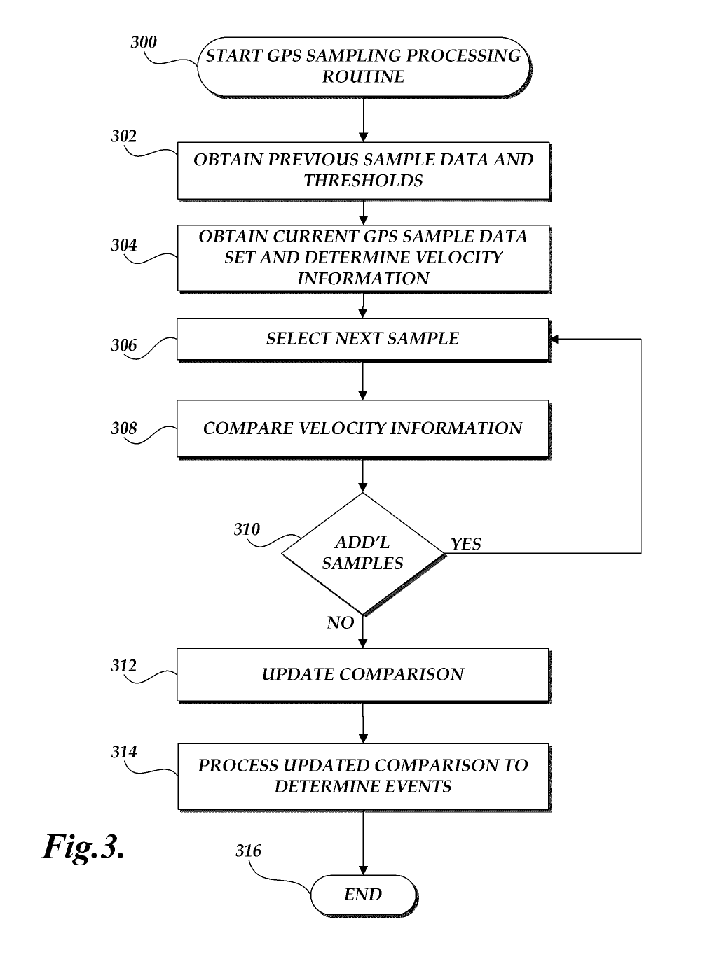

With reference now to FIG. 2, a routine 200 implemented by the mobile communication device 100 to collect a set of positioning signals will be described. At block 202, the mobile communication device 100 initializes a maximum sample size and obtains thresholds for processing the collected positioning signals. Illustratively, a sample is defined as a series of closely spaced positioning signal reads. As will be described with regard to FIG. 3, a sample of multiple positioning signal reads is required to detect reflections. In one embodiment, the smallest maximum size of a sample is 3 positioning signal reads. However, the number of reads in a sample is variable. In one embodiment, the maximum size for a sample can be characterized that for a sample size of a maximum N reads, the number of actual reads (X) taken will lie in the bounded set (N+1)/2<=X<=N (to zero decimal places).

At block 204, the mobile communication device 100 obtains signaling information, such as from a GPS sensor. At block 206, the mobile communication device 100 processes the collected signaling information. Illustratively, a sample consists of 2 or more GPS reads. Additionally, in collecting the two or reads, a power control system can track two metrics regarding GPS fixes. A first metric can correspond to a Time To First Fix (TTFF). TTFF can include a time receive first fix after opening the device. A second metric can correspond to Time To Subsequent Fix (TTSF). TTSF can include a time to receive a valid fix after GPS device has been opened and first fix has been received. Accordingly, in on embodiment, the mobile communication device 100 cans use TTFF and the TTSF to set the timeouts for a valid location fix. For example, if GPS signal is lost while attempting the read, the read may not return for many minutes. If such, the location signal samples may be omitted.

In another embodiment, the mobile communication device 100 can maintain a history of the last N readings and plot them on a standard distribution. Any readings more than 3 standard deviations from the mean distance travelled between subsequent fixes may be discarded. As this can result in readings being discarded when movement first starts after a long stationary, the usual response is to lengthen the sample and request more reads, in effect this is resetting the mean of the distribution after a rapid change in quiescent state (stationary to moving being the most critical).

At decision block 208, a test is conducted to determine whether feedback is required. Illustratively, if no positioning signals are received for an extended time, one cause may be a lack of network assistance data (the GPS almanac and ephemeris data). If positioning signals are not detected for over an hour, using the feedback loop, the mobile communication device 100 can instruct power control logic to override the timeout computed from TTFF and TTSF. Alternatively, if no feedback is required, the routine 200 terminates at block 210.

With reference now to FIG. 3, a routine 300 implemented by the mobile communication device 100 to process the collected set of positioning signals will be described. Routine 300 uses a simple majority voting mechanism to determine if a sample represents a moving sample or a stationary sample when compared to a transition threshold. At block 302, the mobile communication device 100 obtains previously collected positioning signal information, including location information (coordinates) and previous velocity information and obtains velocity thresholds for processing the collected positioning signals.

At block 304, the mobile communication device 100 obtains the collected set of positioning signals to be processed. Additionally, the mobile communication device 100 can also calculate (or have calculated) velocity information based on a comparison of success location coordinates over time. One skilled in the relevant art will appreciate that a number of functions or approximations may be utilized to make the calculations

At block 306, the routine 300 enters into a loop to compare all the positioning signals in the set of collected positioning signals. By selecting a current positioning signal at block 306, the mobile communication device 100 compares velocity information at block 308. In one embodiment, the mobile communication device 100 first compares velocity information obtaining from the positioning signal to determine whether the velocity information (or first velocity information) exceeds a velocity threshold. Based on the comparison, a flag or Boolean logic is set to “true” or “false.” The mobile communication device 100 then compares the calculated velocity information to determine whether the calculated (or second) velocity information exceeds a velocity threshold. Based on the comparison, a flag or Boolean logic is set to “true” or “false.”

In one embodiment, the mobile communication device 100 can make an initial determination of whether the location position signal information is likely valid based on a comparison of the two Boolean values. For example, if the first velocity information is below the velocity threshold, but the second velocity information is above the threshold, the mobile communication device 100 can determine it is likely that the positioning signal is indicative of no valid, such as due to reflection. At decision block 310, a test is conducted to determine whether additional positioning signal information remains in the set. If so, the routine returns to block 306.

Once the mobile communication device 100 has processed the set of positioning signals, at block 308, the mobile communication device 100 conducts an updated analysis. In one embodiment, the mobile communication device 100 can repeat portions of the previous analysis to determine that positioning signals that were interpreted to be valid may be indicative of not being valid.

At block 310, the mobile communication device 100 can characterize the processed data to make assessment regarding the mobile communication device 100 or the collected positioning signal data. Event determination is performed by analysing the GPS sample and determining a movement event. The below table illustrates conclusions that the mobile communication device 100 can determine.

| Sample Analysis | Event |
|---|---|
| All reads GPS invalid | No GPS |
| All reads GPS speed zero, first read average | Moving |
| speed above threshold | |
| Majority of reads below speed threshold | Stationary |
| Majority of reads above speed threshold | Moving |
| Minority of reads showed speed above threshold | Disturbance |
| All reads have valid GPS, but a reflection is detected | Unknown |

At block 312, the routine 300 terminates. The implementation of routine 300 may be illustrated with the below three examples. However, such examples should not be construed as limiting.

### 1. Displacement Detection

The scenario is that the device is moving but in a stop and go scenario. The device has displaced a large distance but the current sample is made while at a stop light, therefore GPS speed is zero. This is the synchronized stop light problem.

| | | | GPS | GPS | | Average |
|---|---|---|---|---|---|---|
| Sam- | Read | | Speed > | Posi- | Average | Speed > |
| ple | Number | Time | threshold | tion | Speed | threshold |
| N-1 | final | tf | | pf | NA | NA |
| N | 1 | t1 | false | p1 | f(pf, p1)(/t1 − tf) | true |
| | 2 | t2 | false | p2 | f(p1, p2)(/t2 − t1) | false |
| | 3 | t3 | false | p3 | f(p2, p3)(/t3 − t2) | false |

It can be deduced the vehicle has recently stopped after traveling a distance at speed. This is a valid displacement because the displacements pf to p1 show displacement exceeded velocity threshold, yet p1 to p2 and p2 to p3 show zero or low displacement velocity.

### 2. Reflection Detection Example 1

While exiting a building, the GPS sample is in progress, the first reading is fairly accurate, but the second reading shows a large displacement as the signal path changes, usually because the GPS device has exited the building and is exposed to the full effect of the reflection. The third reading is accurate as the mobile moves away from the influence of the building

| | | | GPS | GPS | | Average |
|---|---|---|---|---|---|---|
| Sam- | Read | | Speed > | Posi- | | Speed > |
| ple | Number | Time | threshold | tion | Average Speed | threshold |
| N-1 | final | tf | | pf | NA | NA |
| N | 1 | t1 | false | p1 | f(pf, p1)(/t1 − tf) | false |
| | 2 | t2 | false | p2 | f(p1, p2)(/t2 − t1) | true |
| | 3 | t3 | false | p3 | f(p2, p3)(/t3 − t2) | true |

It can be deduced this is a reflection mid sample. The average displacement pf to p1 is in agreement with the GPS reading, yet p1-p2 and p2 to p3 show large displacements in a very short period, resulting in high average velocities.

### 3. Reflection Detection Example 2

On exiting the building the GPS sample starts and the first reading is a reflection, showing a large displacement. The second and third reading is accurate as the mobile moves away from the influence of the building

TABLE 1
Exit building, reflection happens on first sample

| | | | GPS | GPS | | Average |
|---|---|---|---|---|---|---|
| Sam- | Read | | Speed > | Posi- | | Speed > |
| ple | Number | Time | threshold | tion | Average Speed | threshold |
| N-1 | final | tf | | pf | NA | NA |
| N | 1 | t1 | false | p1 | f(pf, p1)(/t1 − tf) | true |
| | 2 | t2 | false | p2 | f(p1, p2)(/t2 − t1) | true |
| | 3 | t3 | false | p3 | f(p2, p3)(/t3 − t2) | false |

This example initially looks very much like the valid displacement, but the position pf is located close to readings p2 and p3, but not p1 resulting in the first two readings in the sample exhibiting high velocity displacement's, because the reflection rapidly collapses whereas a valid displacement would not.

It can be deduced this is a reflection at the beginning of the sample. The average displacement from pf to p1 is high because of the reflection, then displacement is high again p1-p2 then low from p2 to p3.

This logic only fails if the reflections hold through all reads in a sample, this would then look like a permanent displacement. This probability of this scenario can be reduced by increasing the number of reads in the sample. Experience has shown that using a 5 second inter-read interval and a 3 read sample removes 99.9% of all false positives due to reflections.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer-readable medium storing the computer executable components, such as a CD-ROM, DVD-ROM or network interface. Further, the component and/or data can be included in a single device or distributed in any manner. Accordingly, general purpose computing devices may be configured to implement the processes, algorithms and methodology of the present disclosure with the processing and/or execution of the various data and/or components described above. Alternatively, some or all of the methods described herein may alternatively be embodied in specialized computer hardware. In addition, the components referred to herein may be implemented in hardware, software, firmware or a combination thereof.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method, comprising:
collecting a set of positioning signals over a defined period of time, the set of positioning signals corresponding to a maximum number of positioning signals;
processing the set of positioning signals;
for each positioning signal in the set of positioning signals,
determining first velocity information based a current positioning signal;
determining second velocity information based on a calculation of velocity from two successive location coordinates;
performing a first determination regarding validity of the current positioning signal based, at least in part, on a comparison of the first velocity information and the second velocity information;
performing an updating determination regarding validity of each positioning signal in the set of positioning signals based on a second comparison of the first and second velocity information for the set of positioning signals; and
modifying at least one positioning signal in the set of positioning signals based on the updated determination regarding validity of each positioning signal in the set of positioning signals.

2. The computer-implemented method as recited in claim 1, wherein the set of positioning signals correspond to global positioning system signals.

3. The computer-implemented method as recited in claim 1, wherein the maximum number of positioning signals in the set of positioning signals corresponds to three positioning signals.

4. The computer-implemented method as recited in claim 1, wherein processing the set of positioning signals includes removing one or more of the positioning signals based on signal quality.

5. The computer-implemented method as recited in claim 1, wherein determining second velocity information based on a calculation of velocity from two successive location coordinates includes determining velocity based on a heuristic determination of displacement between the two successive location coordinates.

6. The computer-implemented method as recited in claim 1, wherein performing a first determination regarding validity of the current positioning signal based, at least in part, on a comparison of the first velocity information and the second velocity information includes:
determining whether the first velocity information exceeds a velocity threshold;
determining whether the second velocity information exceeds the velocity threshold; and
processing the determination of whether the first velocity information exceeds a velocity threshold and whether determining whether the second velocity information exceeds the velocity threshold.

7. The computer-implemented method as recited in claim 6, wherein performing the updating determination regarding validity of each positioning signal in the set of positioning signals based on a second comparison of the first and second velocity information for the set of positioning signals includes determining a mobile device is stationary if less than a threshold number of comparisons of the first and second velocity information for each of the set of positioning signals is below the velocity threshold.

8. The computer-implemented method as recited in claim 6, wherein performing the updating determination regarding validity of each positioning signal in the set of positioning signals based on a second comparison of the first and second velocity information for the set of positioning signals includes determining a mobile device is moving if more than a threshold number of comparisons of the first and second velocity information for each of the set of positioning signals is below the velocity threshold.

9. The computer-implemented method as recited in claim 6, wherein performing the updating determination regarding validity of each positioning signal in the set of positioning signals based on a second comparison of the first and second velocity information for the set of positioning signals includes determining at least one positioning signal is not valid based on a determination that the second velocity information corresponding to the at least one positioning signal exceeds the velocity threshold and the second velocity information corresponding to other positioning signals in the set of positioning signals do not exceed the velocity threshold.

10. The computer-implemented method as recited in claim 1, wherein modifying the set of positioning signals includes removing one or more positioning signals from the set of positioning signals based on a determination that the one or more positioning signals are not valid.

11. A computer-implemented method, comprising:
for each positioning signal in a set of collected positioning signals,
determining first velocity information based a current positioning signal;
determining second velocity information based on a calculation of velocity from two successive location coordinates;
determining validity of the current positioning signal based, at least in part, on a comparison of the first velocity information and the second velocity information; and
updating the set of collecting positioning signals based on the determined validity.

12. The computer-implemented method as recited in claim 11 further comprising collecting a set of positioning signals over a defined period of time to form the set of collected positioning signals, the set of positioning signals corresponding to a maximum number of positioning signals.

13. The computer-implemented method as recited in claim 11, wherein determining validity of the current positioning signal based, at least in part, on a comparison of the first velocity information and the second velocity information includes:
determining whether the first velocity information exceeds a velocity threshold;
determining whether the second velocity information exceeds the velocity threshold; and
processing the determination of whether the first velocity information exceeds a velocity threshold and whether determining whether the second velocity information exceeds the velocity threshold.

14. The computer-implemented method as recited in claim 13 further comprising includes determining a mobile device whether a mobile device is stationary based on a threshold number of comparisons of the first and second velocity information for each of the set of positioning signals is below the velocity threshold.

15. The computer-implemented method as recited in claim 13 further comprising determining at least one positioning signal is not valid based on a determination that the second velocity information corresponding to the at least one positioning signal exceeds the velocity threshold and the second velocity information corresponding to other positioning signals in the set of positioning signals do not exceed the velocity threshold.

16. A system for comprising:
a location processing component, implemented on a computing device having a processor and a memory, the location processing component operable to:
for each positioning signal in a set of collected positioning signals,
determine first velocity information based a current positioning signal;
determine second velocity information based on a calculation of velocity from two successive location coordinates;
determine validity of the current positioning signal based, at least in part, on a comparison of the first velocity information and the second velocity information; and
update the set of collecting positioning signals based on the determined validity.

17. The system as recited in claim 16, wherein the location processing component is further operable to collect a set of positioning signals over a defined period of time to form the set of collected positioning signals, the set of positioning signals corresponding to a maximum number of positioning signals.

18. The system as recited in claim 16, wherein the location processing component determines the validity of the current positioning signal based, at least in part, on a comparison of the first velocity information and the second velocity information including:
determining whether the first velocity information exceeds a velocity threshold;
determining whether the second velocity information exceeds the velocity threshold; and
processing the determination of whether the first velocity information exceeds a velocity threshold and whether determining whether the second velocity information exceeds the velocity threshold.

19. The system as recited in claim 18 wherein the location processing component determines mobile device whether a mobile device is stationary based on a threshold number of comparisons of the first and second velocity information for each of the set of positioning signals is below the velocity threshold.

20. The system as recited in claim 18 wherein the location processing component determines mobile device whether at least one positioning signal is not valid based on a determination that the second velocity information corresponding to the at least one positioning signal exceeds the velocity threshold and the second velocity information corresponding to other positioning signals in the set of positioning signals do not exceed the velocity threshold.
